(19) United States
(12) Patent Application Publication
(10) Pub. No.: US 2003/0023326 A1
(43) Pub. Date: Jan. 30, 2003

(54) Writing operator panels using direct scan

(76) Inventor: Pranav Shah, Ypsilanti, MI (US)

Correspondence Address: HARNESS, DICKEY & PIERCE, P.L.C., P.O. BOX 828, BLOOMFIELD HILLS, MI, 48303, US

(21) Appl. No.: 10/189,050

(22) Filed: Jul. 2, 2002

Related U.S. Application Data
(60) Provisional application No. 60/302,595, filed on Jul. 2, 2001.

(51) Int. Cl. G05B 11/01; G05B 19/42

(52) U.S. Cl. 700/18; 700/86

(57) ABSTRACT

A programming and control system includes a computer and a flowchart module. The flowchart module is executed by the computer and allows a user to create flowchart-based control logic. An embedded controller that is connected to the computer receives and executes the flowchart-based control logic. An operator panel is connected to the embedded controller and includes a character-based screen. The flowchart module includes an operator panel interface that allows a user of the computer to output text to the character-based screen of the operator panel without requiring the user to create the flowchart-based control logic.

### CROSS REFERENCE TO RELATED APPLICATIONS

This application claims the benefit of U.S. Provisional Application No. 60/302,595, filed Jul. 2, 2001, which is hereby incorporated by reference.

### BACKGROUND AND SUMMARY OF THE INVENTION

The present invention relates to programming and control systems. More particularly, this invention relates to writing operator panels of a programming and control system automatically without requiring programmers to write control logic.

Programming and control systems are generally used for controlling processes that involve electrical and electromechanical devices such as relays, solenoids, motors, valves, switches, diverters, machines, and other similar devices. The processes that are controlled include machining, drilling, welding, spraying paint, mixing materials, assembling parts, handling materials, and other processes. Conventional programming and control systems generally employ ladder diagrams and relay ladder logic (RLL) to control the operation of the devices associated with the processes. In practice, however, programmers tend to use a flowchart to define the operation of the devices in the process. The programmers manually translate the flowchart into the ladder diagrams. The programmers employ the flowcharts as a first step because the flowcharts emulate human thought processes whereas the ladder diagrams do not.

Flowcharts generally include action blocks that represent an operation or action based on current data in the control system. Action blocks may include input or output data. Action blocks generally have one entry point at the top and one exit point at the bottom. A branching or decision block is a diamond-shaped block that represents a branch in the control path based on the result of a decision. Branching blocks generally have one entry point and two exit points. Using the action and branching blocks, a programmer creates a flowchart that controls one or more devices that are associated with a process. Flowcharts dramatically simplify the programming of the devices. One flowchart-based system is disclosed in “Continuous Flowchart, Improved Data Format and Debugging System For Programming and Operation of Machines”, U.S. Pat. No. 4,852,047, which is hereby incorporated by reference.

When the programmer begins a process control project, the programmer must learn about the process, understand control variables that impact the control of the process, and the types of inputs and outputs that the devices will generate. Initially, the programmer connects the devices to the programming and control system. Then, the programmer creates the logic to control the process by adding the action and decision blocks to the flowchart. Most often, the programmer will not create bug-free control logic. When attempting to debug the control logic, it is difficult to determine whether the fault lies in the content of the control logic or in the connections between the programming and control system and the devices. The devices oftentimes include an operator panel that includes a multiple line, character-based screen. The operator panel is connected to an input/output rack of an embedded controller. To eliminate the connection between the programming and control system and the operator panel as the source of the control logic bug, the programmer codes and debugs test control logic that writes to the operator panel to test the connection. This can be particularly time consuming-especially when the programming and control system is associated with many operator panels.

### SUMMARY OF THE INVENTION

A programming and control system according to the present invention includes a computer and a flowchart module. The flowchart module is executed by the computer and allows a user to create flowchart-based control logic. An embedded controller that is connected to the computer receives and executes the flowchart-based control logic. An operator panel is connected to the embedded controller and includes a character-based screen. The flowchart module includes an operator panel interface that allows a user of the computer to output text to the character-based screen of the operator panel without requiring the user to create the flowchart-based control logic.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram illustrating a programming and control system that includes an embedded controller that is coupled to devices that are associated with a process;

FIG. 2 is a functional block diagram of the programming and control system of FIG. 1 illustrated in further detail; and

FIG. 3 illustrates a graphical user interface (GUI) for writing operator panels that are associated with the programming and control system directly.

### DETAILED DESCRIPTION OF THE PREFERRED EMBODIMENTS

The following description of the preferred embodiment(s) is merely exemplary in nature and is in no way intended to limit the invention, its application, or uses.

A graphical user interface (GUI) according to the invention allows programmers to write to character-based operator panels without writing control logic. This ability dramatically saves programming time and allows more rapid development of process control projects.

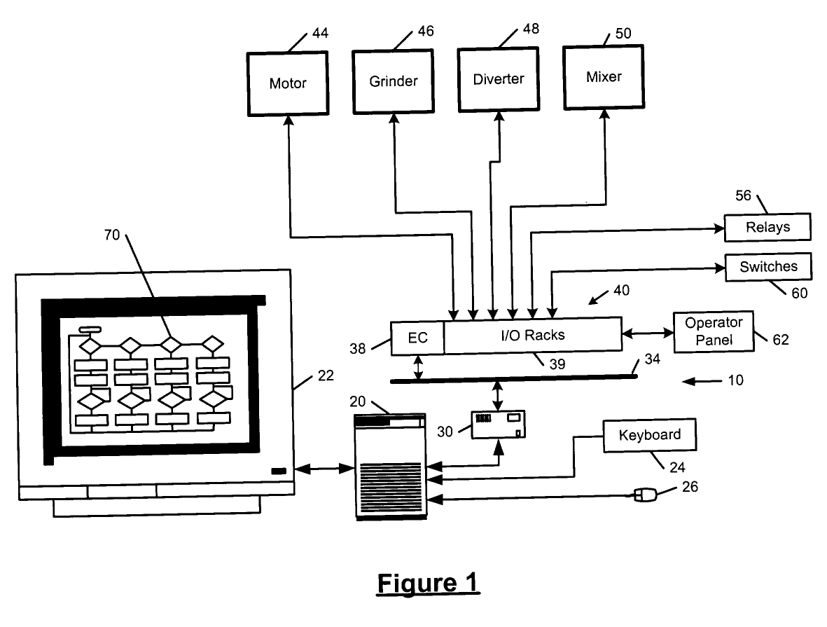

To illustrate the principals of the invention, the exemplary embodiment of FIG. 1 depicts a programming and control system 10 that includes a computer 20. A display 22, a keyboard 24 and a mouse 26 are connected to the computer 20. An input/output (I/O) card 30 such as an Ethernet card is connected in an expansion slot of the computer 20.

A communications or I/O network 34 such as an Ethernet network is connected to the I/O card 30. An embedded controller (EC) 38 is connected to the I/O network 34. Skilled artisans will appreciate that a simple communications interface can be substituted for the EC 38. I/O racks 39 are connected to the EC 38. Electrical and/or electromechanical devices are connected to the I/O racks 39. The exemplary devices include a motor 44, a grinder 46, a diverter 48, a mixer 50, one or more relays 56, and one or more switches 60. The devices 44, 46, 48, 50, 56 and 60 are associated with a process. An operator panel 62 is connected to the I/O racks 39. The operator panel 62 includes a multiple-line, character-based display. Skilled artisans can appreciate that other types of devices can be added to or substituted in the control system 10 without departing from the spirit of the invention. In addition, the operator panel 62 can be connected to the EC 38 or the communications interface. Other I/O cards and networks are also contemplated.

The computer 20 contains a flowchart module that creates, edits, and displays flowcharts 70 on the display 22. The flowchart module generates source code that is compiled into object code directly from the flowchart. Flowchart modules providing such functionality are disclosed in U.S. Pat. No. 4,852,047 that was previously incorporated by reference.

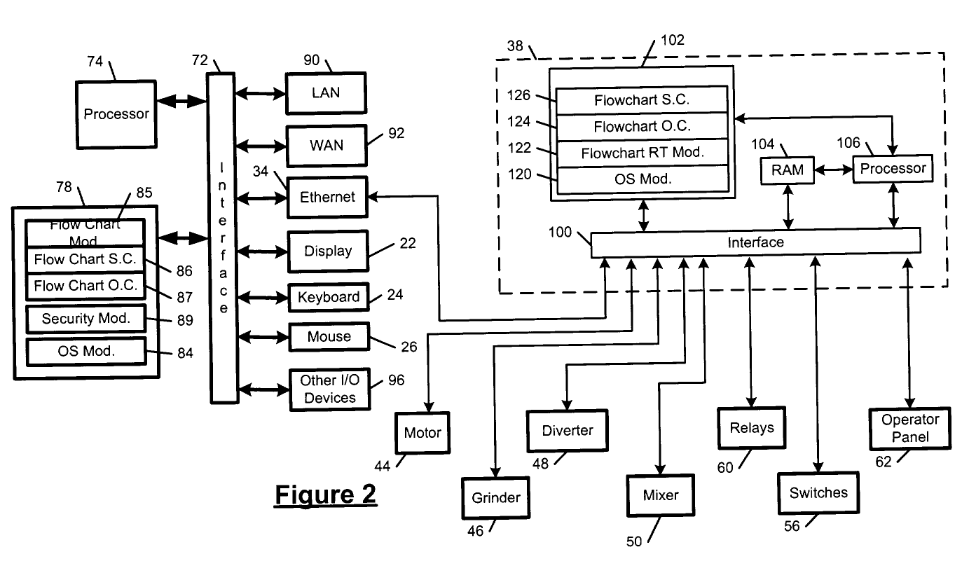

Referring now to FIG. 2, the programming and control system 10 is illustrated further and includes an I/O interface 72, a processor 74, and memory 78 including random access memory (RAM) and read-only memory (ROM). After boot-up, an operating system 84 such as Windows NT®, Windows NTE®, and Windows 2000®, or other suitable operating systems and a flowchart module 85 are loaded into the memory 78. The flowchart module 85 allows a user to create, edit and display the flowcharts 70. As the user generates the flowchart 70, the flowchart module 85 generates flowchart source code 86. When debugged and validated, the flowchart module 85 generates flowchart object code 87 that is generated from the flowchart source code 86. A security module 89 provides password protection, encryption, or other security protocols to prevent unauthorized access.

The computer 20 is connected to a local area network (LAN) 90 and/or a wide area network (WAN) 94 which, in turn, can be connected to the Internet. One or more other I/O devices 96, such as a printer, scanner, etc., may also be connected to the I/O interface 72.

The EC 38 includes an I/O interface 100, ROM 102, RAM 104, and a processor 106. The operator panel 62 is connected to the I/O interface 100. The ROM 102 and/or RAM 106 contains an operating system 120 and a flowchart run-time module or kernel 122, and flowchart object code 124. Optionally, the flowchart source code can be compressed and transmitted to the EC 38. The EC 38 is preferably a Win PLC running Windows CE®. Preferably, the ROM 102 is flash ROM. The flowchart object code 87 is transmitted to the EC 38 through the I/O network 34 for execution by the flowchart run time module 122. If the communications interface is used in lien for the EC 38, the flowchart object code 87 is preferably not loaded on the communications interface. The flowchart source code 86 is compressed by the computer 20 and transmitted via the I/O network 34 to the ROM 102 and/or RAM associated with the EC 38.

The flowchart module 85 separates out the operator panel 62 as another I/O port. The flowchart module 85 preferably addresses the I/O port that is associated with the operator panel 62 using the component object model (COM) without requiring the developer to write separate programs or drivers.

In use, a user launches the flowchart module 85 using the keyboard 24 and/or the mouse 26 when the user wants to create or to edit flowchart projects. The flowchart module 85 is loaded into the memory 78 of the computer. A user creates or edits the flowchart 70 for controlling the devices (the motor 44, the grinder 46, the diverter 48, the mixer 50, the switches 60, and the relays 56) which are associated with the process as will be described further below.

As the user creates the flowchart 70 on the screen, the computer 20 generates the flowchart source code 86 that is then saved in the memory 78. After creation, debugging, and/or simulation is complete, the user compiles the flowchart source code 86 and generates the flowchart object code 87. The computer 20 compresses and transmits the flowchart object code 87 to the ROM 102 and/or RAM 104 associated with the EC 38 (illustrated at 124). Likewise, the flowchart object code 87 is optionally transmitted to the EC 38 (illustrated at 126). The flowchart run-time module 122 executes the flowchart object code 124 that controls the devices connected to the EC 38.

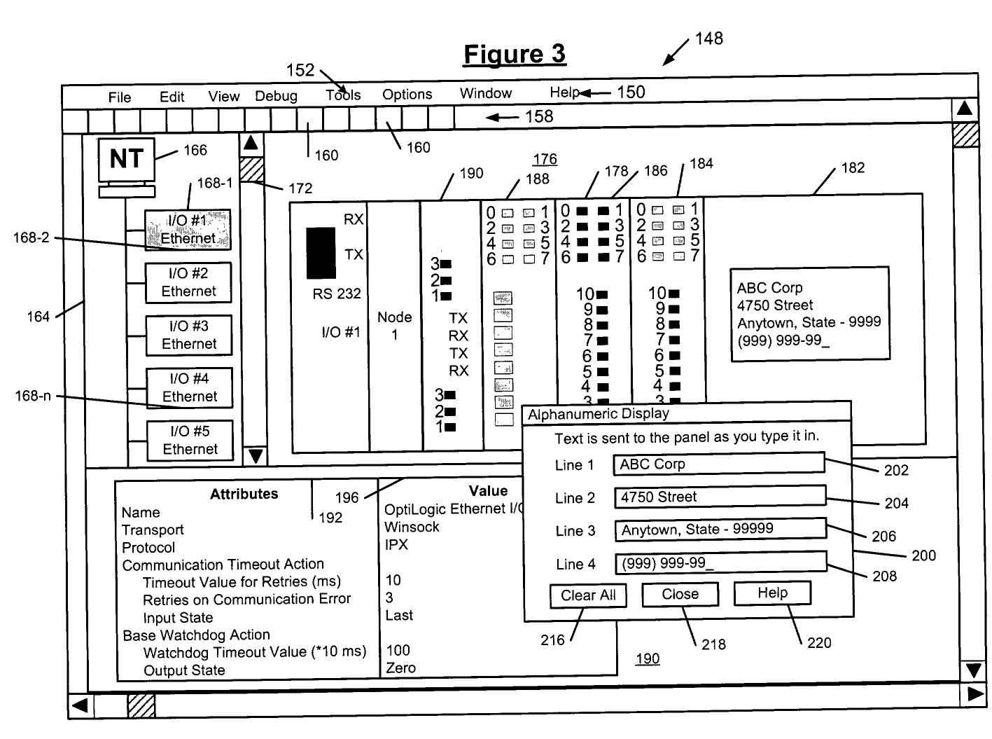

Referring now to FIG. 3, a graphical user interface (GUI) 148 includes a menu bar 150 with a plurality of drop-down menus 152. A tool bar 158 includes a plurality of tools 160. A network display window 164 contains a visual representation of a programming and control network such as a Windows NT system 166 that is connected to a plurality of input/output networks 168-1, 168-2, . . . , 168-n that include the ECₛ 38. One or more of the ECₛ 38 have operator panels 62. The network display window 164 can be navigated using a vertical scroll bar 172. When the user selects an I/O network 168, such as the I/O network 168-1, a graphical representation 178 of the I/O network appears in a window 176. The graphical representation 178 includes a display portion 182 and I/O device status portions 184, 186, 188, and 190. The display portion 182 displays text that appears on the operator panel 62.

A properties window 190 provides attributes and values for the selected I/O network 168. An attributes frame 192 displays name, transport, protocol, communication timeout actions, and base watchdog actions. The communications timeout actions include timeout values for retries (milliseconds), retries on communication errors, and input state. The base watchdog actions specify watchdog timeout values and output states. A values frame 196 allows entry of the specific value for the attributes in the attributes frame 192. The values frame 196 may include combo boxes or drop-down list boxes to limit selections to predefined values.

A dialog box 200 allows a user to input text into one or more of the alphanumeric display of the operator panel 62 without creating logic to write the operator panel 62. The dialog box 200 includes first, second, third and fourth text boxes 202, 204, 206 and 208 that correspond to the first, second, third and fourth lines of the alphanumeric display of the operator panel 62. A command button 216 clears all of the text boxes 202, 204, 206 and 208. A command button 218 closes the dialog box 200. A command button 220 provides content-based help in a pop-up window in a conventional manner. While particular dialog boxes, GUIs and display formats have been disclosed, skilled artisans will appreciate that these design elements can be varied without departing from the invention.

As can be appreciated from the foregoing, the GUI according to the invention allows the programmers to address the character-based operator panels connected to I/O racks that are connected to the embedded controllers of the programming and control system. The operator panels can be written to without requiring the programmer to create control logic. As a result, the programmer saves time and the control project can be completed more quickly.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A programming and control system comprising:
a computer;
a control logic module that is run by said computer and that allows a user to create control logic;
an embedded controller that is connected to said computer and that receives and executes said control logic; and
an operator panel that is connected to said embedded controller and that includes a text-based screen, wherein said control logic module includes an operator panel interface that allows a user of said computer to output text to said character-based screen of said operator panel without requiring said user to create said control logic.

2. The programming and control system of claim 1 further comprising:
a device that is connected to said embedded controller and that is operated by said control logic, wherein said embedded controller interfaces with said device to further a process.

3. The programming and control system of claim 1 wherein said computer is connected to a display and runs an operating system with a graphical user interface.

4. The programming and control system of claim 1 wherein said control logic that is created by said control logic module is flowchart-based control logic that includes action and decision blocks.

5. The programming and control system of claim 1 wherein said embedded controller includes an input/output (I/O) rack and wherein said operator panel is connected to said I/O rack.

6. The programming and control system of claim 1 wherein said computer includes a processor and memory.

7. The programming and control system of claim 3 wherein said control logic module generates, edits and graphically represents a flowchart on a display.

8. A programming and control system comprising:
a computer;
a flowchart module that is executed by said computer and that creates flowchart-based control logic;
an embedded controller that is connected to said computer and that receives and executes said flowchart-based control logic;
an operator panel that is connected to said embedded controller and that includes a character-based screen; and
wherein said flowchart module includes an operator panel interface that allows a user of said computer to output text to said character-based screen of said operator panel without requiring said user to create said flowchart-based control logic.

9. The programming and control system of claim 8 further comprising:
a device that is connected to said embedded controller and that is operated by said flowchart-based control logic, wherein said embedded controller interfaces with said device to further a process.

10. The programming and control system of claim 8 wherein said computer is connected to a display and runs an operating system with a graphical user interface.

11. The programming and control system of claim 8 wherein said flowchart-based control logic includes action and decision blocks.

12. The programming and control system of claim 8 wherein said embedded controller includes an input/output (I/O) rack and wherein said operator panel is connected to said I/O rack.

13. The programming and control system of claim 8 wherein said computer includes a processor and memory.

14. A method of operating a programming and control system, comprising:
providing a control logic module that is run by a computer and that allows a user to create control logic;
connecting an embedded controller to said computer;
receiving and executing said control logic on said embedded controller; and
connecting an operator panel to said embedded controller, wherein said operator panel includes a text-based screen; and
providing an operator panel interface that allows a user of said computer to output text to said character-based screen of said operator panel without requiring said user to create said control logic.

15. The method of claim 14 further comprising:
connecting a device that is operated by said control logic to said embedded controller; and
controlling said device using said embedded controller to further a process.

16. The method of claim 14 wherein said control logic that is created by said control logic module is flowchart-based control logic that includes action and decision blocks.

17. The method of claim 14 further comprising generating, editing and graphically representing a flowchart on a display.
